(19) United States
(12) Patent Application Publication
(10) Pub. No.: US 2002/0059382 A1
(43) Pub. Date: May 16, 2002

(54) System and method for sending electronic mail and computer readable storage medium

(76) Inventors: Akihiko Yamaguchi, Yokohama (JP); Hideko Kagimasa, Yokohama (JP); Katsumi Tada, Kawasaki (JP); Tomomi Yonenaga, Yokohama (JP); Kazuya Kotani, Yachiyo (JP)

Correspondence Address: MATTINGLY, STANGER & MALUR, 104 EAST HUME AVENUE, ALEXANDRIA, VA, 22301, US

(21) Appl. No.: 09/821,077

(22) Filed: Mar. 30, 2001

(30) Foreign Application Priority Data
Nov. 13, 2000 (JP) 2000-345159

(51) Int. Cl. G06F 15/16

(52) U.S. Cl. 709/206; 709/245

(57) ABSTRACT

An electronic mail distribution system and method for sending electronic mail with a writable file for users requested to edit the file contents, and sending electronic mail with a non-writable file for users not requested to edit the contents of the file.

A server device for assigning the attached files edits electronic mail sent from an electronic mail server device, makes electronic mail having information showing processing is complete as TO designated recipient mail, converts an appended file to an non-writable format (such as an image format) as CC designated receiver mail, and also makes electronic mail added with information showing processing is complete, and sends the electronic mail to the electronic mail server device. The electronic mail server device receives the electronic mail showing processing is complete, and sends the electronic mail to the destination.

### BACKGROUND OF THE INVENTION

1. Field of the Invention

The present invention relates to an electronic mail distribution system to send electronic mail with attached files, a method thereof and a storage medium and relates in particular to an electronic mail distribution system to send electronic mail attached with writable files to a designated address, and generate a non-writable file for other addresses, and send electronic mail attached with the non-writable file.

2. Description of Related Art

Along with the explosive growth in Internet users due to low-cost and high performance personal computers, electronic mail has come to be commonly utilized as a means for conveying information. Use of the Internet has also spread in the same way in the business world, so that electronic mail has come to be used a means for conveying information such as business contacts as well as other diverse applications, and currently is an indispensable business tool. In business operations, electronic text fulfills an extremely important role as a medium for business information, and electronic mail is an equally important tool in business as a means for distributing electronic text.

In a general mail system, the main recipient and additional recipients can be separately classified by specifying the address with “TO” or “CC” when sending the electronic mail. In general mail systems, a file can also be attached to the electronic mail. A file attached to the electronic mail is called an attached or appended file.

The user enters the address of a person who will be asked correct the file in the “TO” box of the header, and enters the address of persons who will only read the file in the “CC” box of the header. The users receiving the electronic mail find out how to respond to the electronic mail by checking for their own address in the “TO” box or the “CC” box (hereafter referred to as the first related art).

In Japanese Patent Laid-Open H11-212884 (hereafter referred to as the second related art), an electronic mail transmission device was disclosed for sending electronic mail with an attached file only to addresses requiring attached files from among TO, CC, BCC electronic mail addresses. This electronic mail transmission device was configured as follows. The user enters the addresses for TO, CC, BCC, the main text, attached file and message in the electronic mail transmission device, and when an attached file is specified for any address (such as a TO address) , the mail address links the attached file with the TO address. The mail device next creates TO addressed electronic mail containing the main text and TO address, as well as CC and BCC addressed mail containing the main text and CC or BCC address. The mail device then adds the attached file to TO addressed mail, and does not add the attached file to CC and BCC addressed mail, and also adds a message stating that an attached file was added to the TO addressed electronic mail and then sends the mail to the other (addressee) computer terminal via the network.

In the above first related art, the attached file is sent to either receiver regardless of whether the address was specified in the “TO” or “CC” box. Consequently, the persons receiving the electronic mail all performed the same action in response to the attached file in the electronic mail. In other words, persons other than intended person, also corrected the attached file, issued a reply and returned the file. Restated, there was no clear separation between the person being asked to correct the file and persons not being asked.

In the second related art, a file can be attached to electronic mail only for the user being asked to make corrections, and a file not attached to electronic mail of persons not being asked to correct the file. However, users not being asked to make corrections were unable to check the contents of the appended file.

### SUMMARY OF THE INVENTION

In order to resolve the above mentioned problems in the related art, the present invention has an object of providing an electronic mail distribution system, method thereof and storage medium capable of attaching a writable file to electronic mail to a user asked to correct the file contents, and an non-writable file (such as file contents containing image data) to electronic mail of users not asked to correct the file, and then sending the files.

In order to achieve the above objects, the electronic mail distribution system of the invention is comprised of a mail analyzer to analyze the electronic mail and acquire all 10 or a portion of the attached file, a file creation means to create electronic mail attached with an writable file or a non-writable file according to the address, based on the attached file acquired by the mail analyzer, and a transmission means to send the created electronic mail.

The mail creation means attaches a file in a writable format to the main addressee, and attaches a file in a non-writable format to addresses to receive copies so that the contents of the attached file are not edited or corrected by addressees receiving only copies of the file.

The mail creation means also attaches a file in an writable format or a non-writable format according to the domain of the mail address so that the contents of the file are not edited or corrected by a user having a mail address of a domain other than the user requested to make the correction.

The electronic mail client terminal of the electronic mail distribution system can therefore can be utilized by the previously existing electronic mail server device.

The electronic mail server device of the electronic mail distribution system can therefore be utilized as is, by the previously existing electronic mail client terminal.

To achieve the above mentioned objects, a storage medium may be a program or contain a program to implement the above mentioned functions.

### BRIEF DESCRIPTION OF THE DRAWINGS

FIG. 1 is a block diagram of the electronic mail client terminal in the electronic mail distribution system of the invention.

FIG. 2. is a block diagram of the electronic mail server device in the electronic mail distribution system of the invention.

FIG. 3 is a drawing showing the overall processing of the attached file assignment server device in the electronic mail distribution system of the invention.

FIG. 4 is a drawing showing the overall structure of the attached file assignment server device in the electronic mail distribution system of the invention.

FIG. 5 is a drawing showing the structure of the attached file assignment server device.

FIG. 6 is a PAD (Problem Analysis Diagram) drawing showing the overall processing procedure of the attached file assignment server device.

FIG. 7 is a PAD drawing showing the overall processing procedure for the attached file assignment control program.

FIG. 8 is a PAD drawing showing the processing procedure for the mail analysis program.

FIG. 9 is a drawing showing a list of the mail receivers.

FIG. 10 is a drawing showing the attached file list.

FIG. 11 is a drawing showing another example of the attached file list.

FIG. 12 is a PAD drawing showing the processing procedures for the file list making program.

FIG. 13 is a drawing showing a specific example of OK/NG checks of the file format and conversion processing.

FIG. 14 is a drawing showing a specific example of conversion processing for the file format.

FIG. 15 is a PAD drawing showing the processing procedure of the mail write program.

FIG. 16 is a PAD drawing showing the processing procedure of the mail transmit program.

FIG. 17 is a drawing showing the structure of the electronic mail server device.

FIG. 18 is a PAD drawing showing the overall processing procedure for the electronic mail server device.

FIG. 19 is a PAD drawing showing the processing procedure for the mail assignment program.

FIG. 20 is a PAD drawing showing the processing procedure for another file list making program.

### DESCRIPTION OF THE PREFERRED EMBODIMENTS

The preferred embodiments of the invention are hereafter described while referring to the accompanying drawings.

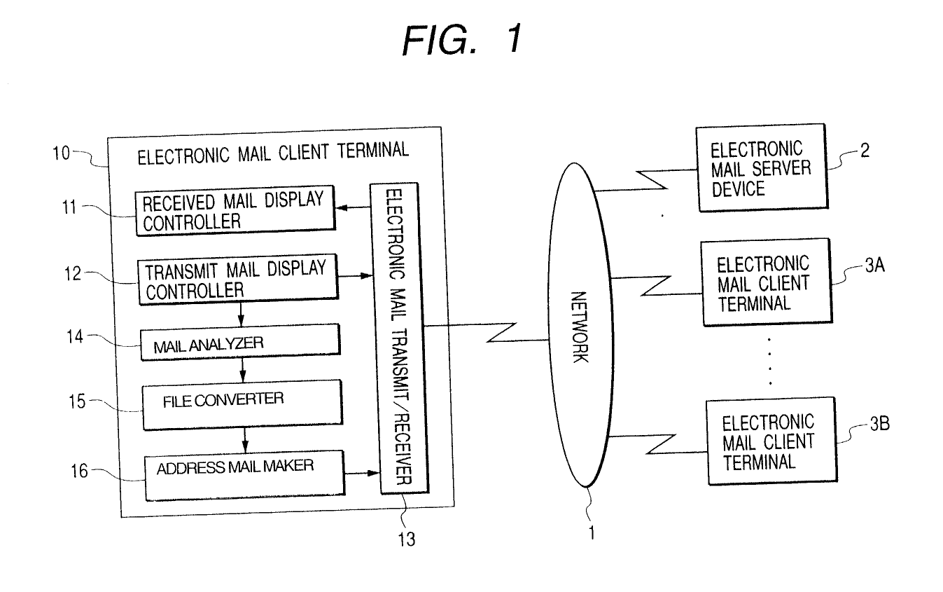

FIG. 1 is a block diagram of an electronic mail client terminal in an electronic mail distribution system of the invention. The electronic mail client terminal 10 of the I electronic mail distribution system of the invention utilizes a personal computer provided with the communication functions with the network. The electronic mail client terminal 10 is comprised of a received mail display controller 11, a transmit mail controller 12, an electronic mail sending and receiving means 13, a mail analyzer 14, a file converter 15, and an address mail maker 16.

Electronic mail client terminals 3A, 3B may contain general purpose mail software and may have the same structure as the electronic mail client terminal 10 in the electronic mail distribution system of the invention. Each of the electronic mail client terminals 10, 3A, 3B and a mail server device 2 are respectively connected to a network 1.

When a mail receive request is made by an input operation means (keyboard, mouse, etc.) not shown in the drawing, the received mail display controller 11 accesses the electronic mail server device 2 by way of the electronic mail sending and receiving means 13 and network 1, receives the electronic mail of the electronic mail client terminal 10, with the user address a accumulated in electronic mail server device 2, and displays the received electronic mail in an image display device not shown on the drawing.

When a request for creating mail is received by an input operation not shown in the drawing, the transmit mail controller 12 displays a screen to enter the text on, and displays a screen to specify the attaching of a file, on a display device not shown in the drawing, and assists the user in creation of the electronic mail.

The received mail display controller 11 and the transmit mail controller 12 may be structured by utilizing general purpose client software.

When the electronic mail is made by means of the transmit mail controller 12, and the user performs the operation to transmit the electronic mail, the transmit mail controller 12 starts up the mail analysis means 14.

The mail analysis means 14 checks whether or not a file has been attached to the electronic mail that was made and checks if a copy distribution (CC, BCC) was set or not for the recipients.

When a file was attached to the electronic mail that was made, and when the attached file is only for the main recipient addressee (TO), the mail analyzer 14, grants transmit permission to the transmit mail controller 12, and the electronic mail with the attached file is sent to the electronic mail server device 2 by way of the electronic mail sending and receiving means 13.

When a file has been attached to the electronic mail that was made and when a copy distribution address (CC, BCC) was set for that electronic mail, the mail analyzer 14 supplies the attached file to the file converter 15 and also supplies the electronic mail with attached file to the address mail maker 16. The mail analyzer 14 also supplies the electronic mail with attached file to the address mail maker 16.

The file converter 15 converts the attached file into a file with a format that does not allow writing (non-writable file format). Files in a non-writable format for instance are files in a read-only format that allows only reading and does not permit writing such as image data files and facsimile files. Specific examples of attached files are assumed to be a variety of files such as text files made by a word processor, files made by spreadsheet software, files made by CAD software and HTML files utilized for displaying home pages. The file converter 15 may convert the contents of the attached file to print output images, and converts the print output images to data for still images, and generate image data format files or facsimile format files.

The address mail maker 16 generates electronic mail for the electronic mail addresses by means of the transmit mail controller 12. The address mail maker 16 creates electronic mail for the main recipient of the mail and attached file listed in (TO).

The address mail maker 16 also creates electronic mail having an attached non-writable file attached to the mail text for the copy distribution addresses in (CC, BCC). The address mail maker 16 then sends the electronic mail to the electronic mail server device 2 of the main recipient by way of the electronic mail sending and receiving means 13, and also sends electronic mail to the electronic mail servers 2 of the copy distribution addresses by way of the electronic mail sending and receiving means 13.

When for example, the main recipient (TO) is the main client terminal 3A, that mail client terminal 3A receives the electronic mail with attached file just as designated by the sender. The user of the mail client terminal 3A can therefore not only read the contents of the attached file but can also correct (write) the contents of that file.

When the mail recipient is the copy distribution address (CC, BCC) for the electronic mail client terminal 3B, that electronic mail client terminal 3B receives electronic mail attached with a file in a non-writable format. The user (recipient) of the electronic mail client terminal 3B, can therefore read the contents of the file but cannot correct (write) the file contents.

The user (sender of the electronic mail) of the electronic mail client terminal 10 of this invention can therefore specify an addressee (TO) as the main recipient requested to correct the attached file, and for all other recipients can make electronic mail designated with a copy distribution address (CC, BCC), carry out the sending of this electronic mail in the usual manner, so that electronic mail with an attached file capable of being written is sent to the main recipient (TO), and all other addresses (CC, BCC) are sent electronic mail with an attached file not capable of being written on.

The electronic mail client terminal 10 of this invention is comprised of a file conversion means 15 and a address mail maker means 16 so that an electronic mail with attached file capable of being written is sent to the main recipient (TO) just by making an electronic mail with attached file the same as for ordinary mail software, and making electronic mail with attached files in a format not allowing writing for other recipient (CC, BCC).

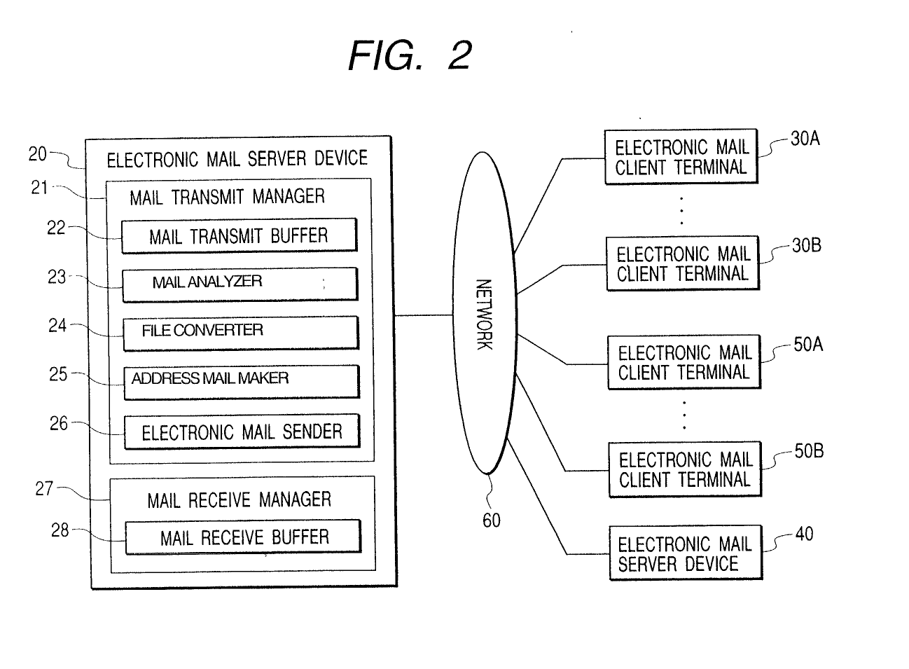

FIG. 2. is a block diagram of the electronic mail server device in the electronic mail distribution system of the invention. The electronic mail server device 20 for the electronic mail distribution system of the invention is comprised of a mail transmit manager 21 for controlling the receiving of electronic mail sent from the electronic mail client terminals 30A, 30B belonging to the electronic mail server device 20, and a mail receive manager 27 to receive electronic mail sent to the electronic mail client terminals 30A, 30B belonging to the electronic mail server device 20 from other electronic mail server devices 40.

The mail transmit manager 21 is comprised of a mail transmit buffer 22, a mail analyzer 23, a file converter 24, an address mail maker 25 and an electronic mail sender 26.

The mail receive manager 27 is comprised of the mail receive buffer 28. The electronic mail client terminals 50A, 50B belong to the other electronic mail server device 40. The electronic mail server devices 20, 40 and the electronic mail client terminals 30A, 30B, 50A, 50B are respectively connected to the network 60.

The mail receive manager 27 receives electronic mail addressed to the electronic mail client terminal (user) 30A, 30B belonging to the electronic mail server device 20 from the other electronic mail server device 40, and stores the received electronic mail in the mail receive buffer 28. When the mail receive manager 27 is supplied with an electronic mail 25 extraction request from the electronic mail client terminals 30A and 30B, the electronic mail request address is extracted from the mail receive buffer 28 and supplied to the electronic mail client terminals 30A, 30B.

When the mail transmit manager 21 transmits electronic mail from the electronic mail client terminals (user) 30A, 30B belonging to the electronic mail server device 20, that electronic mail is first stored in the mail transmit buffer 22 and the mail analyzer 23 is started up.

The mail analyzer 23 checks the destination address of the electronic mail and whether or not a file is attached. When no file is attached to the electronic mail, or even if a file is attached but the mail is addressed only to the main recipient (TO), then that electronic mail is sent to the specified destination address by way of the electronic mail sender 26. When the specified destination address is a user belong to this electronic mail server device 20, that electronic mail is stored in the mail receive buffer 28.

When the mail analyzer 23 specifies electronic mail with attached file and besides the main recipient also specifies 20 the copy distribution address (CC, BCC), the attached file is supplied to the file converter 24, and the destination address is supplied to the header, the main text of the electronic mail, and the attached file is supplied to the address mail maker means 25.

The file converter 24 converts the attached file to a non-writable format file, and supplies the converted non-writable format file to the address mail maker 25. Non-writable format files are for example, write-prohibited, read-only format files that are capable of being read but not written on, such as image data files, or facsimile files.

Specific examples of attached files are assumed to be a variety of files such as text files made by a word processor, files made by spreadsheet software, files made by CAD software and HTML files utilized for displaying home pages. The file conversion means 24 may convert the contents of the attached file to print output images, and converts the print output images to data for still images, and generates image data format files or facsimile format files.

The address mail maker 25 generates electronic mail 15 for the electronic mail addresses.

The address mail maker 25 creates electronic mail for the main recipient of the mail and attached file listed in (TO). The address mail maker 25 also creates electronic mail having an attached non-writable file attached to the mail 20 text for the copy distribution addresses in (CC, BCC). The address mail maker 25, along with sending electronic mail for the main recipient to the other electronic mail server device 40 by way of the electronic mail sender 26, also sends copy distribution addressed electronic mail to the electronic mail 25 server device 40 by way of the electronic mail sender 26.

When the destination address of the electronic mail automatically by the address mail maker 25 is addressed to a user belonging to this electronic mail server device 20, this automatically generated electronic mail is stored in the mail receive buffer 28.

When the electronic mail client terminal 50A is the main recipient specified with (TO), then electronic mail can be made with an attached file capable of being corrected (written on) and sent to the electronic mail client terminal 50A. The user (receiver) of the electronic mail client terminal 50A can therefore not only view the attached file but can also correct the file contents.

When the electronic mail client terminal 50B is a copy distribution recipient specified with (CC, BCC), electronic mail with an attached file in a format not capable of being written on is sent to the electronic mail client terminal 50B. The electronic mail client terminal 50 user (receiver) can therefore view the contents of the attached file but cannot correct the file contents.

The user (sender of the electronic mail) for the electronic mail client terminal 10 of the invention therefore only need specify the address of a main recipient (TO) requested to correct the attached file contents, and/or can make electronic mail specified for all other recipients (CC, BCC) and then just send the electronic mail.

The electronic mail server device 20 of the invention contains a file converter 24 and an address mail maker 25 so that electronic mail, with an attached file capable of being corrected (written on) and addressed to a main recipient (TO) is made, and electronic mail with an attached file not capable of being corrected (write-protected) is made addressed to all other recipients (CC, BCC). The electronic mail made for other addresses is sent to each address by way of the electronic mail sender 26.

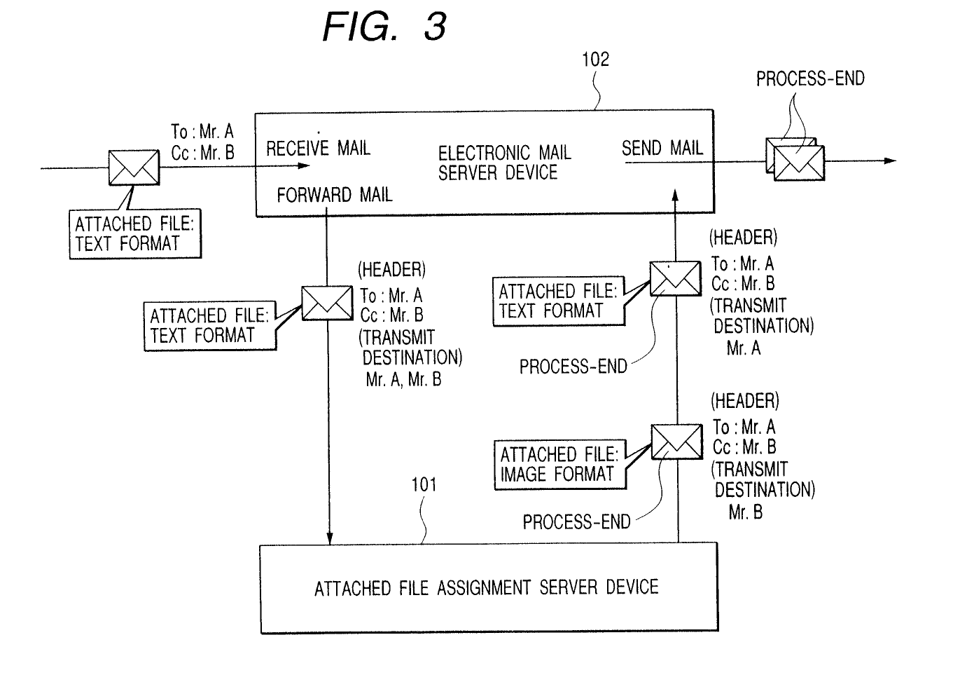

FIG. 3 is a drawing showing the overall processing of the attached file assignment server device in the electronic mail distribution system of the invention.

When electronic mail is received, the electronic mail server device 102 sends the applicable electronic mail to the attached file assignment server device 101. The attached file assignment server device 101 edits the electronic mail and makes electronic mail for the receiver specified in TO, and added with information showing that processing of the applicable electronic mail is complete, and converts attached files not capable of being corrected (such as image files) for mail for recipients specified in CC and further adds information shown in that processing of that mail is complete and sends the mails to the electronic mail server device 102. When the electronic mail server device 102 receives the electronic mail added with information showing that processing is complete, it sends the received electronic mail to the specified address. Therefore, in the above process, electronic mail added with files in a writable formation is sent to a recipient specified in TO, and electronic mail added with a file in a non-writable format are sent to a recipient specified in CC.

The sender of the mail therefore simply specifies in TO, a recipient (user) to be given writing privileges on an attached file, and sends mail by the usual operation to recipients (users) specified in CC not allowed to write on the attached file so that the attached file assignment server device 101 can automatically send a mail with a writable file or a non-writable file according to the address so that a dedicated mail client terminal and dedicated mail client software are not required, and the sender of the electronic mail can control the right of the electronic mail recipient to attached text. In this way, the effect is rendered that inappropriate or undesired revisions of the text information are prevented.

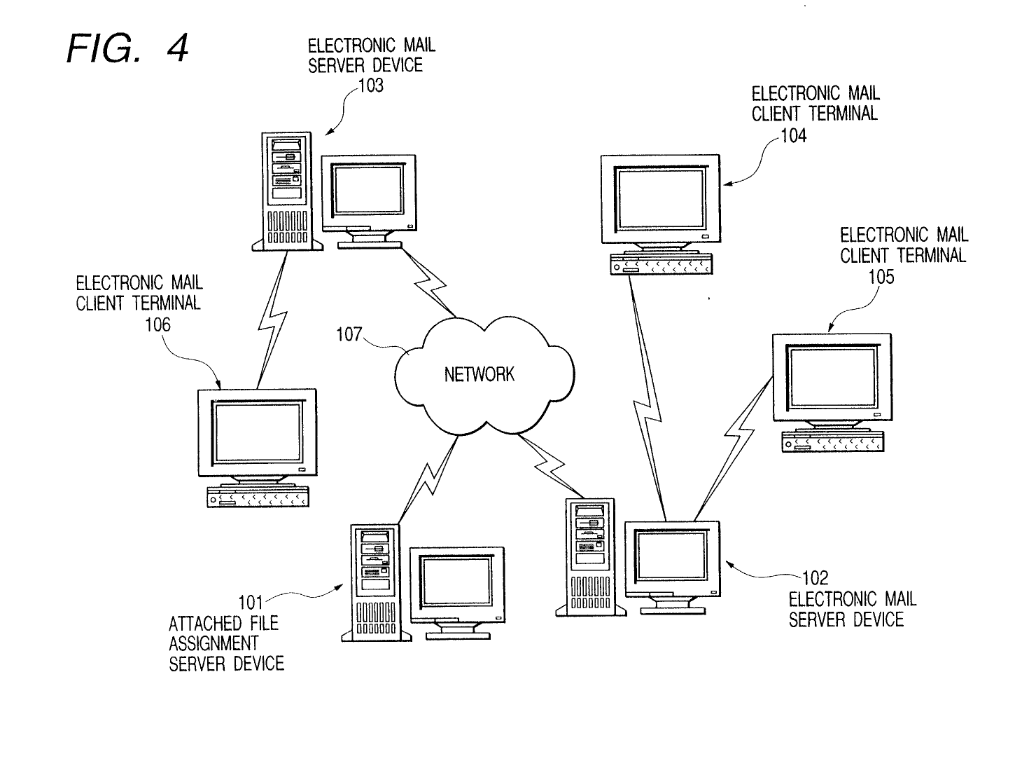

The structure of the attached file assignment server device 101 of the electronic mail distribution system is next described. FIG. 4 is a drawing showing the overall structure of the attached file assignment server device in the electronic mail distribution system of the invention.

The electronic mail distribution system as shown in FIG. 4 is comprised of an attached file assignment server device 101, a plurality of electronic mail server devices 102, 103, a plurality of electronic mail client servers 104, 105, 106 and a network 107.

When the attached file assignment server device 101 receives the mail, it analyzes the applicable mail, acquires the mail recipient list, attaches the appropriate attached file to the correct respective mail recipient, and after adding a mark (hereafter, listed as process-end mark) showing that processing is complete, sends the mail.

When the electronic mail server devices 102, 103 receive the mail, the applicable mail is analyzed, a check made as to whether a process-end mark has been added. If no process-end mark was added, the mail is sent to the attached file assignment server device 101. If a process-end mark has been added, the mail is distributed in the conventional manner.

The electronic mail client terminals 104, 105, 106 display a screen for showing the electronic mail made by the user, and send the electronic mail made by the user on this screen to the electronic mail server devices 102, 103 connected (affiliated) with the user. The electronic mail client terminals 104, 105, 106 download the electronic mail arriving from the electronic mail server devices 102, 103 connected (affiliated) with the user, and display the applicable mail on the display screen.

The network 107 is a network such as LAN or WAN. The attached file assignment server device 101, the electronic mail server devices 102, 103 and the electronic mail client terminals 104, 105, 106 are used to send control information such as commands and data of various types.

In the example of FIG. 4, separate computers were used in the attached file assignment server device 101 and the electronic mail server devices 102, 103 however as structure using the same computer is also possible.

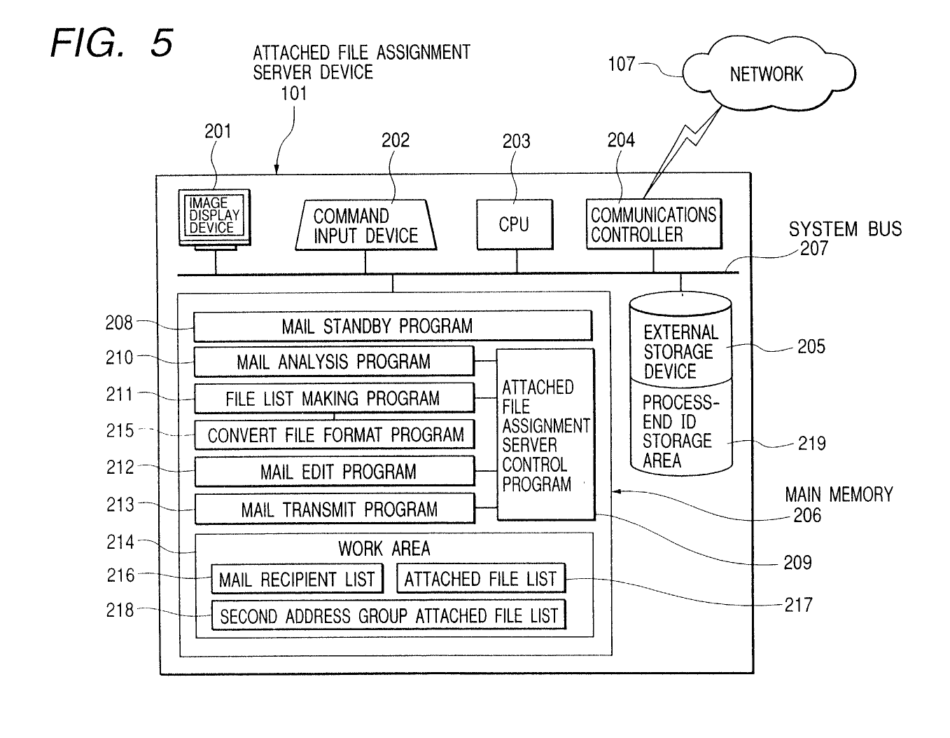

The attached file assignment server device 101 is described next. FIG. 5 is a drawing showing the structure of the attached file assignment server device. The attached file assignment server device 101 shown in FIG. 5 is comprised of a display (image display device) 201, an command input device 202, a central processing unit (CPU) 203, a communications controller 204, an external storage device 205, a main memory 206, and a system bus 207.

The display 201 is used for showing the processing status in this system. The command input device 202 is a device for giving instructions to the computer such as by a mouse or keyboard, and gives commands such as for program startup, etc.

The central processing unit (CPU) 203 implements the various programs on the attached file assignment server device 101. The communications controller 204 is used for exchanging commands and data between the electronic mail server devices 102, 103 by way of the network 107.

The external storage device 205 is used to store all types of data for implementing the processing with the attached file assignment server device 101. The main memory 206 is used to temporarily hold the data and programs for implementing the processing with the attached file assignment server device 101. The system bus 207 is used to connect these respective devices.

The process-end ID storage area 219 is held inside the external storage device 205. This storage area is utilized to store message ID from processed mail.

A mail standby program 208 to await incoming mail, an attached file assignment server control program 209, a mail analysis program 210, a file list making program 211, a file format conversion program 215, a mail edit program 212, and a mail transmit program 213 are contained inside the main memory 206, and a work area 214 is also held within the main memory 206. The work area 214 is used for storing the data required for implementing programs.

When a program starts up due to a startup command from the command input device 202, the mail standby program 208 awaits electronic mail for the applicable program, and when the mail is received, starts up the attached file assignment server control program 209.

When the electronic mail is received as an input, the attached file assignment server control program 209 starts up and runs the mail analysis program 210, the file list making program 211, the mail edit program 212, and the mail transmit program 213.

The mail analysis program 210 receives the electronic mail as an input and creates a list of applicable mail recipients, that is a mail recipient list 216, and also makes an attached file list of the applicable mail, that is, an attached file list 217 in the work area 214.

The file list making program 211 receives the attached file list 217, starts up the file format conversion program 215 to convert the file format, and creates a second address group attached file list 218.

The mail edit program 212 receives the mail recipient list 216, the attached file list 217, the second address group attached file list 218 and the electronic mail, creates the proper electronic mail for the recipient, and stores them in the work area 214.

The mail transmit program 213 transmits the electronic mail created by the mail edit program 212 to the respective recipients.

Next, the overall processing procedures of the attached file assignment server device 101 are described. FIG. 6 is a PAD (Problem Analysis Diagram) drawing showing the overall processing procedure of the attached file assignment server device.

When the mail standby program 208 starts up due to a server startup command from the command input device 202, the applicable program is a set in a mail awaiting loop (step S1). This loop continues until a server stop command (stop command of attached file assignment server device) from the command input device 202. The loop of step S1 repeats the step S2 (mail reception) for receiving electronic mail, and step S3 for starting the attached file assignment server control program 209.

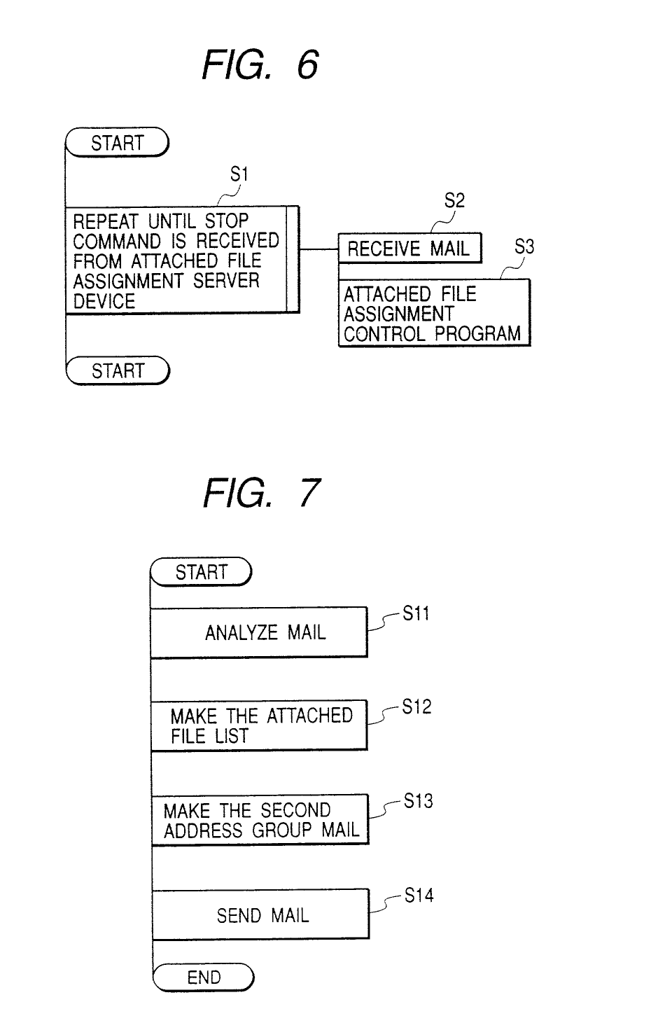

FIG. 7 is a PAD drawing showing step S3 in detail, that is, a PAD drawing showing the overall processing procedures for the attached file assignment server control program 209.

The attached file assignment server control program 209 receives the mail data as an input, and first of all, analyzes the applicable mail in step S11, and then makes the mail recipient list 216 and the attached file list 217.

A typical mail recipient list 216 is shown in FIG. 9. In the example shown in FIG. 9, the mail recipients are categorized into TO and CC, with recipients specified in TO set as the first address group, and recipients specified in CC set as the second address group.

Next, in step S12, when the recipient is in the second address group, a list of attached files of second address group recipients that is, a second address group attached file list 218 is made.

Next, in step S13, the mail for the second address recipients (hereafter, “second address group mail”) is made.

Finally, in step S14, the original mail is sent to the first address group, and mail for the second address group is sent to the second address group, and the processing ends.

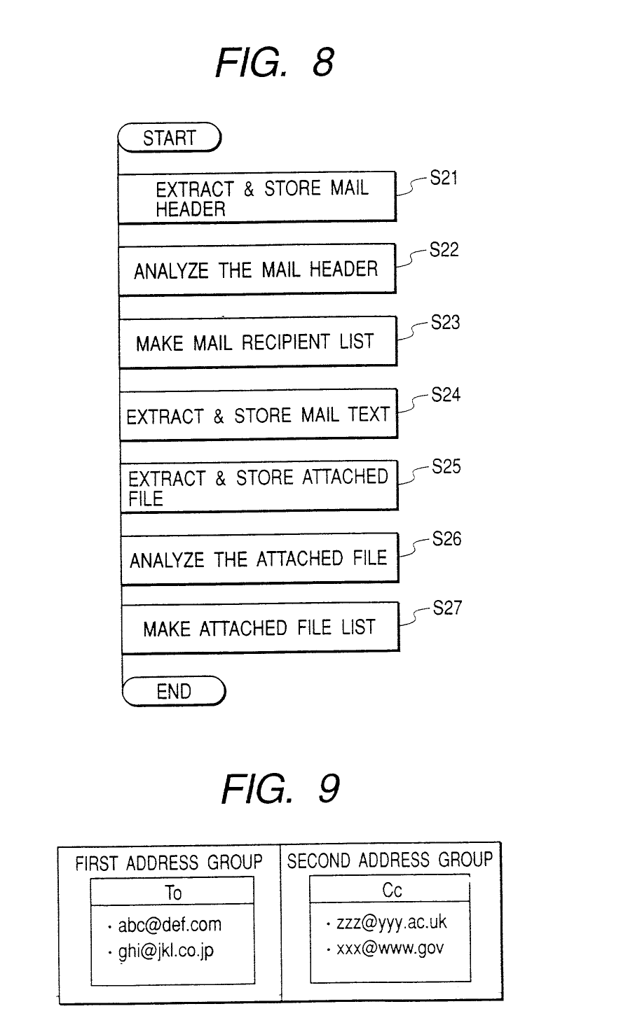

FIG. 8 is a PAD drawing showing the process of step S1 in detail, that is, the processing procedure of the mail analysis program 210.

The mail analysis program 210 receives the mail data as an input and starts up. In step S21, the header is extracted from the applicable mail data and stored in the work area 214. In step S22, the header is analyzed and all mail recipient addresses listed in the TO field and CC field and as well as the message ID are acquired. If the message ID acquired here is present inside the process-end ID storage area 219, then the processing ends. If the message ID is not present inside the process-end ID storage area 219, then the acquired message ID is stored.

In step S23, an area for the mail recipient list 216 is obtained in the work area 214, and the address acquired in the applicable area is separated and stored in the first address group (TO) and the second address group (CC), and the mail recipient list 216 is made (See FIG. 9).

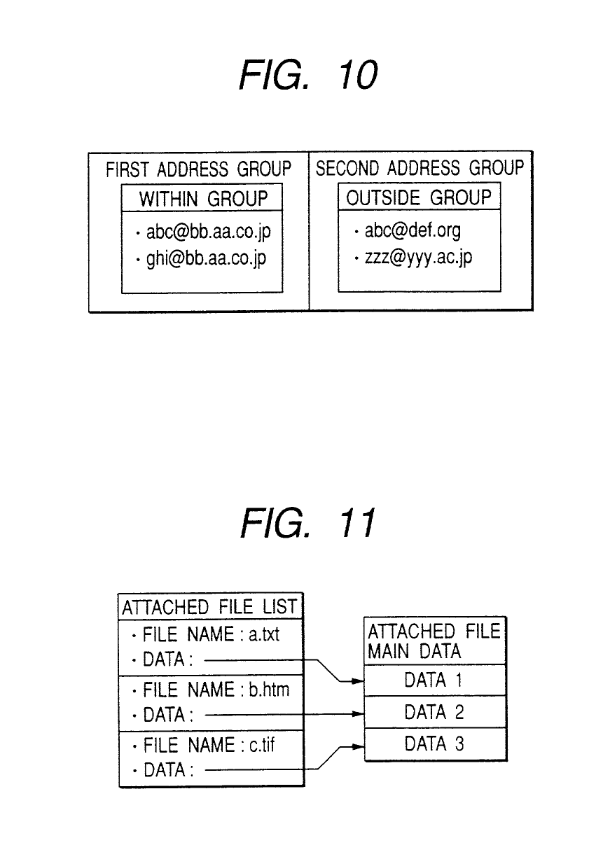

In the example in FIG. 9, the mail recipients were grouped into TO and CC, however the mail recipients can also be grouped according to domain. As shown in FIG. 10, the first address group can be classified in the domain bb.aa.co.jp, and the second address group can be classified as recipients in domains other than bb.aa.co.jp, and the mail recipient list 216 also made. An attached file having a writable format in mail of an address within one grouping, can also be automatically attached as a file in a non-writable format to mail for other domains.

In step S24, as shown in FIG. 8, the mail main text is extracted from the mail data, and stored in the work area 214. In step S25, the attached file data are extracted one by one from the mail data, and stored separately as attached file data in the work area 214. However, since the size of the attached file is usually large, the attached file data is stored within the external storage device 205, and only the information specified on the file in the external storage device 205 need be held in the work area.

In step S26, the attached file data stored in step S25 is analyzed, and the attached file name and attached file main data are acquired. When the attached file is encoded, the decoding is performed in this step. In step S27, the attached file name and attached file main data acquired in step S26, are stored in the related work area 214, and the attached file list 217 is made (See FIG. 11).

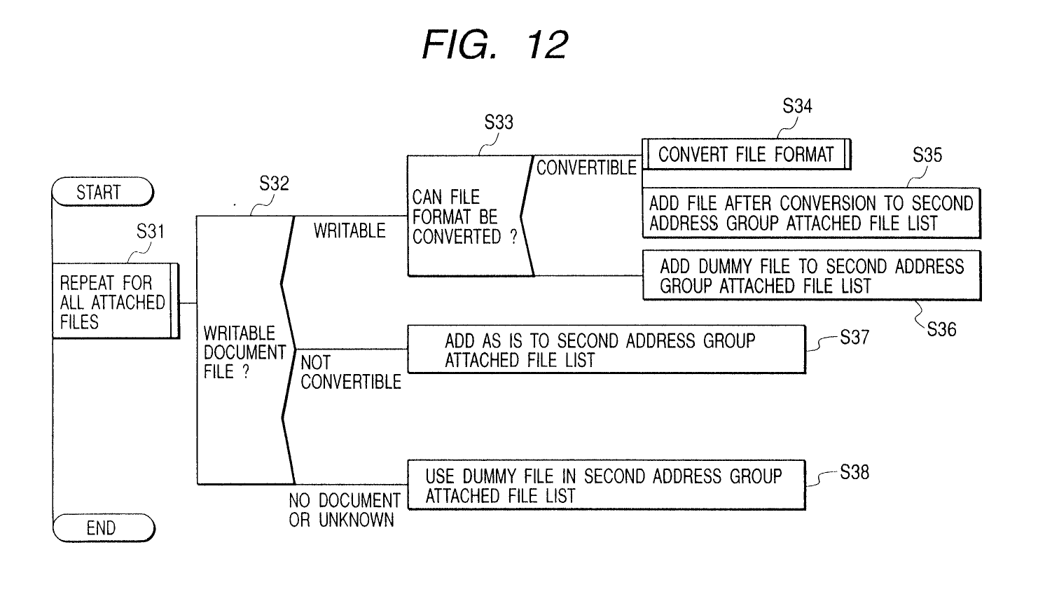

FIG. 12 a PAD drawing showing the process of step S12 in FIG. 7 in detail, that is, the processing procedure of the file list making program 211.

The file list making program 211 receives as an input the attached file list 217, made by the mail analysis program 210. In step S31, the file list making program 211 repeats the processing shown from steps S32 to steps S38 for each attached file in the attached file list 217.

In step S32, the file format of the attached file for processing is inspected and checked to find if the text of the attached file is writable (or editable). If the text of the applicable attached file is writable, then the processing branches to step S33. If the applicable attached file is non-writable, then the processing branches to step S37. If the applicable attached file is not a text file or is a file of an unknown format, then the processing branches to step S38.

In step S33, the file format of the attached file for processing is investigated and if a check made to determine if the attached file format is capable of being converted or not. When the applicable attached file is found capable of being converted, the processing branches to step S34, and in all other cases the processing branches to step S36.

In step S34, the attached file for processing is converted to a non-writable format such as an image format. In step S35, the file is added to the second address group attached file list 218, after conversion of the file format by the process shown in step S34.

In step S36, a dummy file prepared beforehand is added to the second address group attached file list 218. The dummy file contains information whose contents report that the attached file constituting the current file for processing was not sent to the second address group recipients.

In step S37, the attached file for the processing is added unchanged to the second address group attached file list 218.

In step S38, the dummy file prepared beforehand is stored in the applicable area in the second address group attached file list 218. The dummy file contains information whose contents report that the attached file constituting the current file for processing was not sent to the second address group recipients.

Here, the processing of step S12 is described utilizing an example, in other words the processing for the file list making program 211 is described. As related above, the file list making program 211 receives as an input, the attached file list 217 made by the file analysis program 210. An example of the attached file list 217 is shown in FIG. 11. The file list making program 211 first of all, acquires an extension from each file. In the example shown in FIG. 11, the first attached file is “txt”, the second attached file is “htm”, and the third attached file is “tif”.

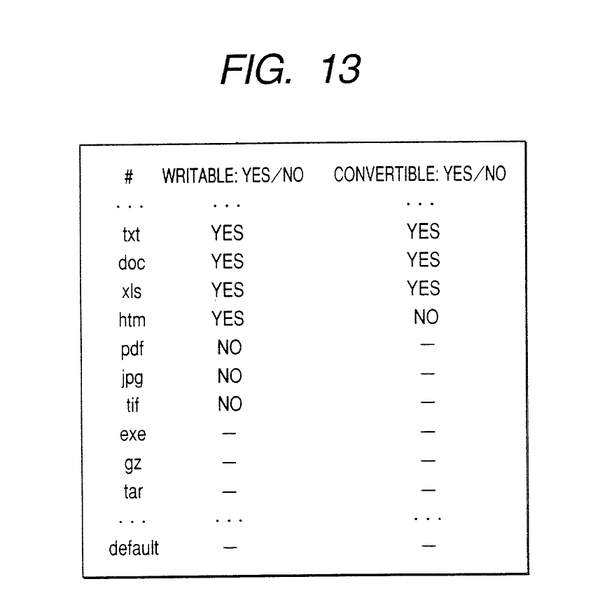

Next, a check is made to determine if the file for processing is writable (editable) or not, using a file such as shown in FIG. 13, and if the file format is convertible or not. In the example, shown in FIG. 13, the extension, “txt” of a file shows that the file is writable, the extension “htm” of a file shows that the file is writable, and the extension, “tif” of a file shows that the file is non-writable. Whether or not a file is writable is determined based on this information, and a check is made in the same way on whether the format of the file for processing can be converted. If a line for the extension of the file for processing is not present in the file shown in FIG. 13, then a determination is made based on information listed on the “default” line. The “-” in FIG. 13, indicates the information is unknown.

Next, the procedure for adding a file to the second address group attached file list 218 is described. In step S32 of FIG. 12, the “a. txt” file is determined to be writable and the process proceeds to step S33. In step S33, the file is determined to be convertible and the process proceeds to step S34. In step S34, the file is converted from text format to an image format, and in step S35 is added to the second address group attached file list 218.

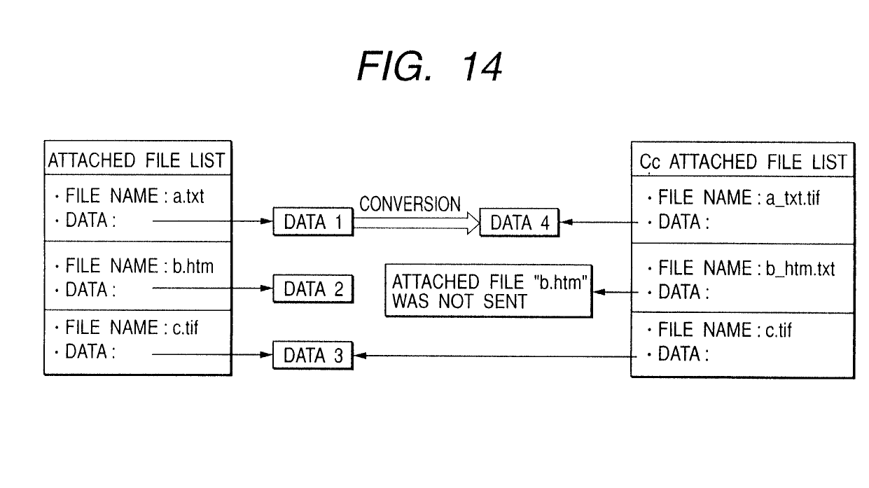

As shown in FIG. 14, the file format prior to conversion can be known by storing the file under the name, “a_txt.tif”. For a file with the extension, “b.htm”, when determined in step S32 of FIG. 12 that the file has a writable format, the processing proceeds to step S33. In step S33, when determined that conversion is impossible, the processing proceeds to step S36. In step S36, the information that an attached file “b.htm” was not transmitted is added to the second address group attached file list 218. For file, “c. tif”, when determined in step S32 of FIG. 12 that the format is non-writable, the processing proceeds to step S37, and “c. tif”, is added unchanged to the second address group attached file list 218. As a result of the above processing, a second address group attached file list is made as shown by the example in FIG. 14.

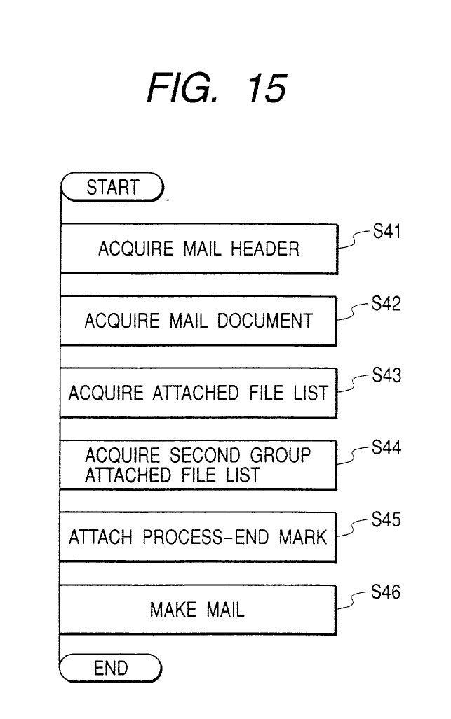

FIG. 15 is a PAD drawing showing details of the processing of step S14 in FIG. 7, that is, the processing procedure of the mail write program 212.

In step S41, the mail header stored in the work area 214 in step S21 is acquired. In step S42, the mail text stored in the work area 214 in step S24 is acquired. In step S43, the attached file list 217 stored in the work area 214 in step S25 is acquired. In step S44, the second address group attached file list 218 made in work area 214 by the file list making program 211 is acquired.

In step S45, an expansion field (hereafter described as process-end mark) is attached to the mail header acquired in step S41 to show that processing of the mail is complete. In step S46, a first address group mail is made utilizing the attached file list 217, and mail text and mail header acquired in steps S42 and S43, and a second address group mail is made utilizing the second address group attached file list, and mail text and mail header acquired in steps S41, S42 and steps S44, and the respective mail stored in the work area 214.

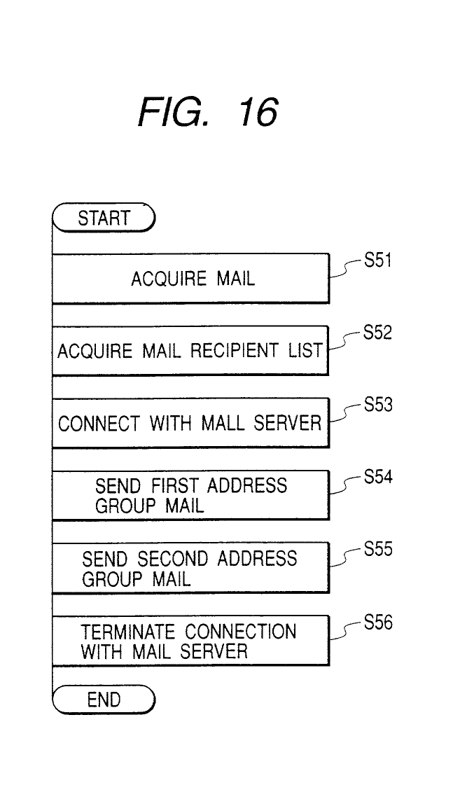

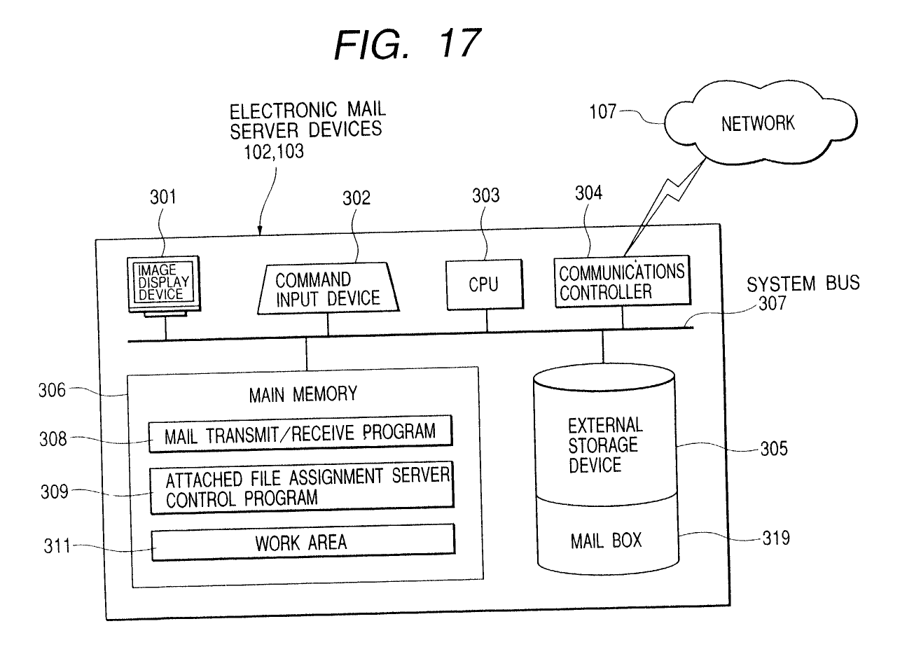

FIG. 16 is a PAD drawing showing details of the processing of step S14 in FIG. 7, that is, the processing procedure of the mail write program 213.

In step S51, the first address group mail and the second address group mail made by the file list making program 211 in step S51 is acquired. In step S52, the mail recipient list 216 made by the mail analysis program 210 in step S52 is acquired. In step S53, a connection request is issued to the electronic mail server device 102, and a connection established with the electronic mail server device 102.

In step S54, the mail address of the first address group recipient is acquired from the mail recipient list 216, and the first address group mail is sent to the applicable mail address. In step S55, the mail address of the second address group recipient is acquired from the mail recipient list 216, and the second address group mail is sent to the applicable mail address. In step S56, a connection termination request is issued to the electronic mail server device 102, and the connection with the electronic mail server device 102 is terminated.

The above description is the explanation of the attached file assignment server device 101.

The electronic mail server devices 102 and 103 are described next. The structure of the electronic mail server device is shown in FIG. 17. The electronic mail server devices 102 and 103 are comprised of a display device (image display device) 301, a command input device 302, a central processing unit (CPU) 303, a communications controller 304, an external storage device 305, a main memory 306, and a system bus 307.

The display 301 is used for showing the processing status within the system. The command input device 302 is a device for giving instructions to the computer such as by a mouse or keyboard, and issues commands such as for program startup, etc. The central processing unit (CPU) 303 implements the various programs on the electronic mail server devices 102 and 103. The communications controller 304 is used for exchanging commands and data between the attached file assignment service device 101 and the electronic mail client terminals by way of the network 107.

The external storage device 305 is used to store all types of data for implementing the processing with the electronic mail server devices 102 and 103. The main memory 306 is used to temporarily hold the data and programs for implementing the processing with the electronic mail server devices 102 and 103. The system bus 307 is used to connect these respective devices.

A mail box 319 is held within the external storage device 305. The mail box 319 is used to store the user mail data holding the accounts for the electronic mail server devices 102 and 103. The work area 311 storing the mail transmit program 308 and the mail assignment program 309 is held within the main memory 306. The work area 311 is used to store the required data for implementing the program.

When the mail sending and receiving program 308 is started by a program command from the command input device 302, the applicable program waits for the electronic mail and when the electronic mail is received, the mail sending and receiving program 308 distributes the electronic mail to the mail addresses.

The mail assignment program 309 is triggered to start up when the electronic mail is distributed to the recipient's mailbox. The electronic mail is then received as an input, the applicable electronic mail analyzed, and when a process-end mark has been added to the applicable electronic mail, the electronic mail is returned to the mailbox 310, and when no process-end mark has been added to the applicable electronic mail, the applicable mail is sent to the attached file assignment service device 101.

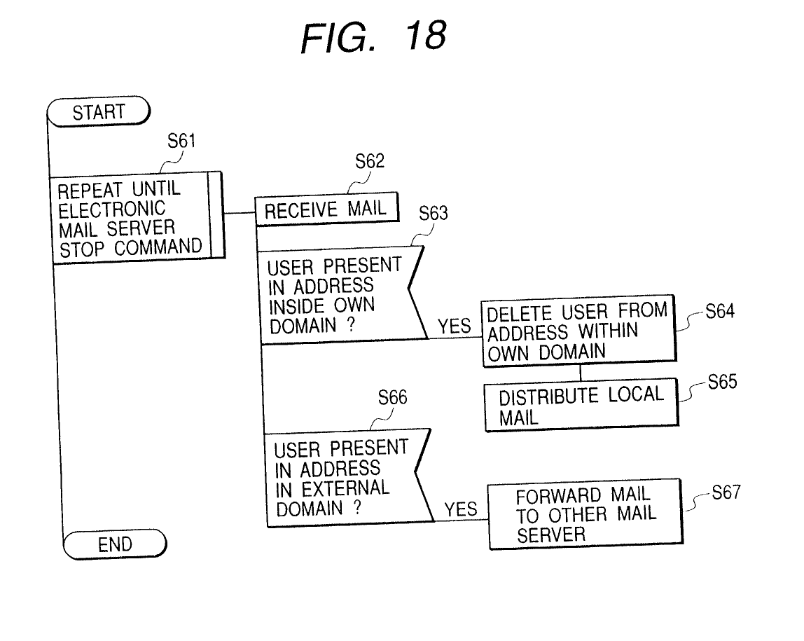

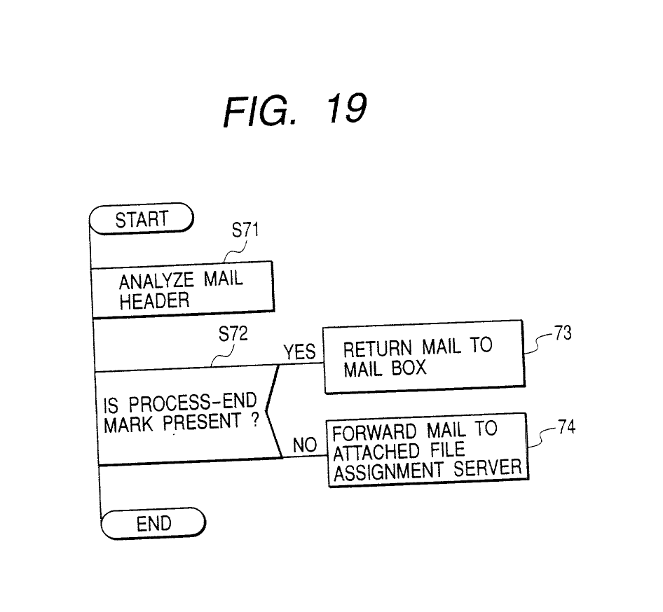

The overall processing procedures for the electronic mail server devices 102 and 103 are described next. FIG. 18 is a PAD drawing showing the overall processing procedure for the electronic mail server devices 102 and 103.

When the mail sending and receiving program 308 starts up by receiving a server start command from the command input device 302, the applicable program enters a loop awaiting incoming mail (step S61). This loop continues until an electronic mail server stop command is given from the command input device 302. The loop of step S61 repeats the processing shown from steps S62 to step S67.

The electronic mail is received in step S62. In step S63, the mail address is investigated, and if a user exists within the same domain as the address, then the process proceeds to step S64. In step S64, the user within the same domain is eliminated from the mail address. In step S65, the mail data is sent to the applicable user area in the mailbox 319. In step S66, the mail address is investigated, and if an external domain address, the process proceeds to step S67. In step S67, the mail is sent to the applicable domain.

The processing procedures for the mail assignment program 309 are described next. FIG. 19 is a PAD drawing showing the processing procedure for the mail assignment program 309.

The mail assignment program 309 is triggered when the electronic mail is sent to the recipient's mailbox. When the electronic mail is received as an input, analysis of the mail header is first performed in step S71. In step S72, if a process-end mark is present mail header, the process proceeds to step S73, and if there is no process-end mark in the mail header, then the process proceeds to step S74. In step S73, the electronic mail is returned to the mailbox 319. In step S74, the applicable mail is sent to the attached file assignment service device 101.

This completes the description of the electronic mail server devices 102 and 103.

As described above, in the electronic mail distribution system of the invention, the sender of the mail specifies a user (recipient) in TO who is to be granted rights to change the attached file, or the sender of the mail specifies a recipient in CC who is not be granted rights to update the attached file, and when the electronic mail is transmitted by the usual method, the electronic mail with the attached original file is sent by the sender to the recipient specified in TO, and mail attached with a file converted to a non-writable format is sent by the sender to the recipient specified in CC.

Consequently, the use of dedicated mail software is not required, and the sender of the mail can control the rights of the recipient of the electronic mail with attached document so that the unwanted or unauthorized revision of the text information (or document) is prevented.

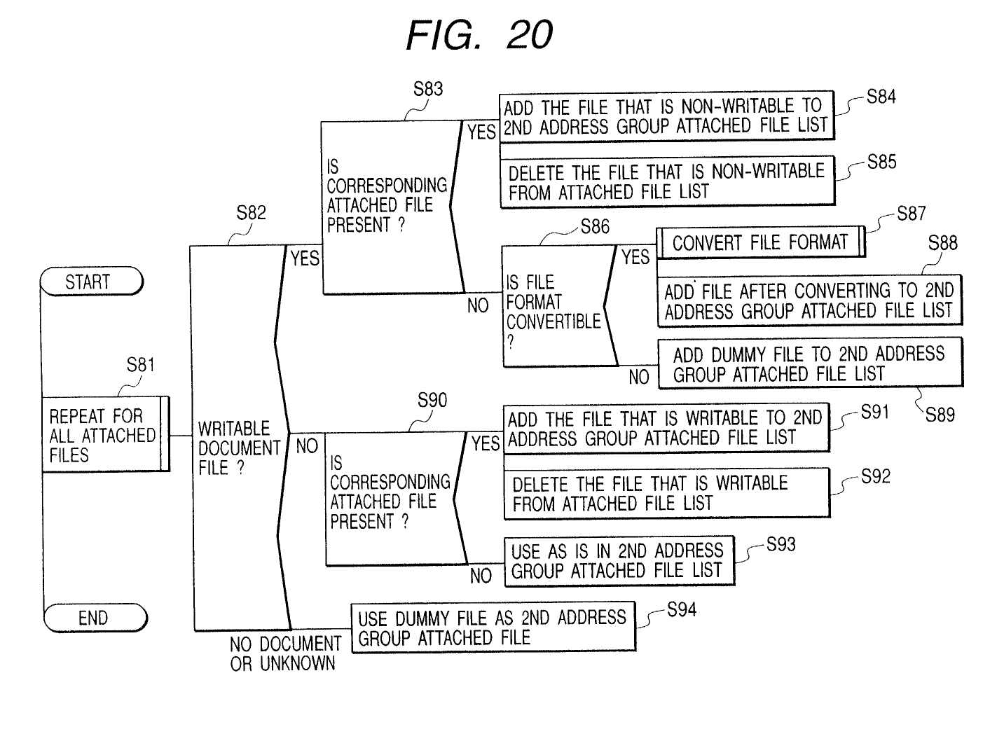

Next, the attached file assignment server device in the second embodiment of the electronic mail distribution system is described while referring to FIG. 20. The structure of the electronic mail distribution system in the second embodiment is identical to the structure of the first embodiment, however the processing procedures of the file list making program 211 are different. FIG. 20 is a PAD drawing showing the processing procedure for another file list making program 211 in the second embodiment.

The file list making program 211 receives the attached file list 217 as an input from the mail analysis program 210. In step S81, the processing procedures shown in steps S82 through S94 are repeated for each attached file in the attached file list 217.

In step S82, the file format of the attached file for processing is investigated and a decision made as to whether the attached file document (text) is writable or not. When determined that the document of the attached file is writable (editable), the process branches to step S83. When determined that the document (text) of the attached file is non-writable (not editable), the process branches to step S90. If the attached file is not a text (document) file or has an unknown format, then the process branches to step S94.

In step S83, the file name of the attached file for processing is investigated, and whether or not only the file name and extension are different, and if the attached file format is for a non-writable file are investigated. If such a file type is present, then the process branches to step S84. If such file types are not present then the process branches to step S86.

In step S84, non-writable format files from among the attached files for processing and corresponding files (acquired in step S83) are added to the second address group attached file list 218. In step S85, the attached files added to the second address group attached file list 218 are deleted from the attached file list 217.

In step S86, the file format of the attached file for processing is investigated, and a determination made whether or not that attached file format can be converted to another document (text) format. If the applicable attached file can be converted to another format, then the process branches to step S87. In all other cases, the process branches to step S89.

In step S87, the attached file for processing is converted to a non-writable format such as an image format. In step S88, the file whose format was converted in step S87, is added to the second address group attached file list 218.

In step S89, the dummy terminal prepared beforehand is stored in an applicable area in the second address group attached file list 218.

In step S90, the file name of the attached file for processing is investigated, and whether or not only the file name and extension are different, and if the attached file format is for a non-writable file are investigated. If such a file type is present, then the process branches to step S91. If such file types are not present then the process branches to step S93.

In step S91, the non-writable format files from among the attached files for processing and corresponding files (acquired in step S90) are added to the second address group attached file list 218. In step S92, the attached files added to the second address group attached file list 218 in step S91, are deleted from the attached file list 217.

In step S93, the attached files for processing are added unchanged to the second address group attached file list 218.

In step S94, the dummy file prepared beforehand is added to the second address group attached file list 218.

Therefore as described above, in the attached file assignment server device in the second embodiment of the invention, the sender of the mail specifies user recipients intended to receive rights to write (or correct) the attached file in TO, and specifies user recipients not to be granted rights to write (or correct) the attached file in CC, and by further attaching both the attached file for recipients specified in To, and the attached file for recipients specified in CC to the electronic mail and sending that electronic mail; the recipient specified in To is sent only the electronic mail with attached file specified for the TO recipient, and likewise the recipients specified in CC are sent only the electronic mail with attached file specified for the CC recipients.

Consequently, though the mail sender must prepare beforehand the attached file for the recipient specified in TO, and the attached file for the recipient specified in CC, dedicated mail client software is not required. Further, the sender of the electronic mail can decide on the attached file for the recipient specified in TO and the attached file for the recipients specified in CC so that the granting of rights to the attached document (or text) to the recipients can be controlled, and the unwanted or inappropriate revision of the document (text) information can be prevented.

This invention is not however limited by the examples in the above described embodiments.

The present invention may also be comprised of a recording medium storing a program to implement the electronic mail distribution system on a computer, and may for example be comprised of a various types of recording mediums such as magnetic tape, CD-ROMs, IC cards, or RAM cards, etc.

In the electronic mail distribution system of the invention as described above, electronic mail can be made and sent attached with a writable file designated for a specified addressee, and attached with a non-writable file designated for other addressees.

By designating an address as the main recipient address (TO) , and other addresses as the copy distribution addressees (CC, BCC), writable (editable) files can be sent as attached files to the main recipient address (TO) and non-writable (non-editable) files can be sent as attached files to the copy distribution addresses (CC, BCC).

The present invention can be achieved with an electronic mail client terminal device on an already existing electronic mail server.

By implementing on an electronic mail server, the existing electronic mail client terminal device can be utilized as is, without changes.

By connecting an attached file assignment server device comprising a file converter and an address mail making means, the electronic mail server device can forward electronic mail from the electronic mail client terminal to the attached file assignment server device so that the existing electronic mail client terminal device can be utilized as is, without changes.

In the electronic mail distribution system of the invention as described above, electronic mail attached with a writable file can be sent to a user asked to write on (or edit) the file contents, and electronic mail attached with a non-writable file can be sent to a user not asked to write on (or edit) the file contents. The contents of the attached file cannot therefore be changed by a user not asked to write on (or edit) the file contents.

What is claimed is:

1. An electronic mail distribution system comprising, a mail analysis means for analyzing the electronic mail to acquire all or a portion of an attached file, a mail creation means for creating electronic mail attached with an writable file or a non-writable file according to a mail address, based on the attached file acquired by the mail analysis means, and a transmission means for sending the created electronic mail.

2. An electronic mail distribution system according to claim 1, wherein the mail creation means attaches a file in a writable format to a main recipient address and attaches a file in a non-writable format to a copy distribution recipient addressee.

3. An electronic mail distribution system according to claim 1, wherein the mail creation means attaches a file in a writable format or a file in a non-writable format according to a domain of the mail address.

4. An electronic mail distribution system according to claim 1, wherein the file in a non-writable format is an image data format file obtained by converting contents of a writable format file to print output images, and converting the print output images to data for still images.

5. An electronic mail distribution system according to claim 1, wherein the mail distribution system is an electronic mail client terminal.

6. An electronic mail distribution system according to claim 1, wherein the mail distribution system is an electronic mail server device.

7. An electronic mail distribution method for distributing electronic mail with an attached file, comprising the steps of, analyzing electronic mail to acquire the attached file, making a file in a writable format or a file in a non-writable format file according to a mail address from the acquired attached file, making electronic mail with a writable format file for the main recipient address and making electronic mail with anon-writable file for the copy destination recipient address, and then sending the created electronic mail.

8. An electronic mail distribution method according to claim 7, wherein the contents of the attached file are converted to a printed output image, and the results from converting the printed output image to still image data is an image data format file.

9. An electronic mail distribution method according to claim 7, wherein when a non-writable format file cannot be made from the acquired attached file, a dummy file is made holding information notifying that the attached file currently being processed was not sent to the copy distribution addressee, and electronic mail added with the applicable dummy file is sent to the copy distribution addressee.

10. A computer-readable storage medium recorded with a program to operate the electronic mail distribution system, the medium for the system comprising, a mail analysis means utilizing a computer to analyze electronic mail by computer and acquire all or a portion of attached files, a mail creation means for creating electronic mail attached with an writable file or a non-writable file according to a mail address, based on the attached file acquired by the mail analysis means, and a transmission means for sending the created electronic mail.
